(19) United States
(12) Patent Application Publication
(10) Pub. No.: US 2004/0245426 A1
(43) Pub. Date: Dec. 9, 2004

(54) Modular hanging system for objects

(76) Inventor: Willard Lowell Barnes JR., Anaheim, CA (US)

Correspondence Address: MICHAEL A. SHIPPEY, PH. D., 4848 LAKEVIEW AVENUE, SUITE B, YORBA LINDA, CA, 92886, US

(21) Appl. No.: 10/455,533

(22) Filed: Jun. 5, 2003

(51) Int. Cl. B60R 1/02

(52) U.S. Cl. 248/466

(57) ABSTRACT

This invention relates to a device for mounting and securing pictures, frames, and other objects onto a surface, such as a wall or other support, which device is made up of a tool by which the object can be placed in level position against the surface and a tool by which the object can be securely fastened to the surface. This device can be removed and reused in the event the object is moved to another location.

### FIELD OF THE INVENTION

The invention relates generally to a device for hanging objects on vertical or slanted wall surfaces. More specifically, it relates to a hanging device having one part affixed to the object and a second part affixed to the wall such that the two parts can be matched together for purposes of hanging the object. The device is intended to eliminate tedious position measurements while providing a secure mounting for the object being hung. This device offers a fast, easy, efficient, inexpensive, and reusable means for hanging objects. It is preferably used in relation to wall surfaces such as dry wall or wallboard that can be punctured using mild to moderate hand-force. A primary objective of the device is to eliminate the necessity of having to pre-measure, pre-drill, and otherwise prepare a wall prior to mounting objects on it.

### DESCRIPTION OF THE RELATED ART

The prior art shows a variety of devices that try to solve the problem of hanging and mounting objects on vertical or vertically angled support surfaces so that the objects hang horizontally level, in preferred locations, and in desirable relationship to other hanging objects. These devices emphasize different means of measuring the placement of the hangings to secure them onto the support surface so that the object can then be hung onto the hangings and the objects can later be adjusted if necessary to a horizontally level position.

U.S. Pat. No. 6,409,140 teaches a tool to measure the preferred placement of two hangings for a single object, such that the hangings are inserted into the tool, which is then held against the support so the hangings can be secured to the support or the placement of the hangings can be marked at the preferred distance apart and in a horizontally level position, after which the tool is then removed.

U.S. Pat. No. 6,357,716 teaches an apparatus that sets the placement of a hanging using a straightedge tool with a sliding feature to allow variation in the distance between two hangings, which placement can then be marked and the tool removed.

U.S. Pat. No. 5,303,895 teaches an apparatus that is attached to the frame of an object to be hung before the frame is mounted on the support surface, which apparatus has a built-in level to ensure horizontally level positioning and which apparatus is then secured to the wall. This apparatus is fairly intricate, expensive, and requires significant time and effort to secure it to the frame and the wall.

Some prior art instructs on devices that are attached to the object so that after it is hung, the object can be shifted to, or maintained in, a horizontally level position. Such a device is described in U.S. Pat. No. 2,952,431, which teaches a cross bar that attaches to the object's frame and is inserted into an end piece to level the object. U.S. Pat. No. 417,805 teaches such a device that pierces the supporting wall and attaches to the object hung so that the object does not move. U.S. Pat. No. 2,506,519 teaches a device with sharp points that are inserted into the supporting wall to keep the hanging object in position. None of these devices secure the object to the wall, but only concern the position of the object after it has been hung.

Much prior art has been devoted to hangings that are made for specific types of objects or for hanging objects on specific types of supports. U.S. Pat. No. 3,219,302 teaches a one-piece metal hanging of a unique configuration that can be pushed into dry wall by hand pressure and that is self-locking once inserted into the wall. U.S. Pat. No. 3,049,323 teaches apillar-shaped hanging with cut-away holes in specific configurations to allow an object to hang with space between it and the support. U.S. Pat. Nos. 2,928,199 and 1,908,147 teach hangings that are tamper and theft-proof. U.S. Pat. Nos. 2,577,661, 2,204,862, 1,856,923, and 1,829,521 teach various hangings for mirrors, glass, and other heavy articles. U.S. Pat. No. 1,496,282 teaches a hanging with a slot and pin that can be pushed into a wall. U.S. Pat. No. 1,297,584 teaches a hanging that has angled prongs on opposite sides of a plate for insertion into the object being hung and into the wall. These prior art devices offer no means of measuring the placement of the hangings or the horizontal positioning of the object integral to the hangings themselves.

There remains a need for an improved method of hanging objects that is inexpensive, requires less time, is more accurate than painstaking measurements, and is reusable such that objects can be quickly removed and placed in a different position or location. The process of hanging objects has, in the past, always required several steps: measuring for placement of the object on the support, securing a hanging device to the support, securing a corresponding hanging device to the object, and finally, matching the two hanging devices together to hang the object.

This process is rendered even more difficult if an object is hung so that the hanging is behind the object and not visible. In such event, measurements must be made for the position of the object's frame in relation to the position of the hanging device behind the object. Once the hanging is in place, the second required procedure involves a “blind” hanging of the object because the hangings are directly behind the object and cannot be seen, even for purposes of mounting the object onto the supporting wall.

The process of hanging objects is time-consuming because the parts of the process are each separate from the other. That is, the measurement for placement is not physically integrated with the hanging, and often there are two matching hangings—one on the wall, one on the object—that are separate from each other. The separate nature of each of these parts creates a margin for error that increases with each step in the process. Thus, if the measurement is a quarter inch off, the hanging secured to the wall is another quarter inch off, and the connecting hanging secured to the object is yet another quarter inch off, the margin of error increases each time, and the consumer ends up with several trial-and-error holes in the wall to achieve the preferred position for the hanging object. When one makes measurements, it is easy to make mistakes. Hence the famous carpenter's rule “measure once, cut it short; measure twice, cut it right.”

Because it is difficult to hang objects in a horizontally level position at just the preferred place, hanging objects takes much careful planning and tedious work and requires a significant commitment of time. If multiple objects need to be hung, it can take hours and even days to achieve just the right placement. The difficult and time-consuming process of hanging objects is especially a problem when objects are regularly hung in a temporary display and are then relocated. While this step-by-step process may be warranted in some situations, such as when the object is extremely heavy or must be secured from theft, it is a cumbersome process for average consumers.

### SUMMARY OF THE INVENTION

This invention relates to a device for mounting pictures, frames, and other objects onto a vertical or vertically angled wall or other support, which device consists of a mounting assembly that is attached to the object and that has a specially designed feature for marking the desired hanging position for the object simply by holding the object against the surface where it is to be hung, and a nail retainer that is affixed to the wall at the desired position and also serves to keep the mounting assembly securely in place. Both parts of this hanging device are needed to complete the mounting. This device can be easily removed and reused if the object is moved and hung in another location.

An objective of the present invention is to provide a hanging system that is easy and efficient to use in terms of effort and time and that requires no measurement of the position or horizontal placement for the hanging device. In the first embodiment of the present invention, an object can be hung in five simple steps that do not require precise measurement to achieve the desired location and horizontal position. First, one or more of the mounting assemblies are attached to the object. This first step can even be performed by the manufacturer of a frame or object in advance of sale. By this means a consumer would be able to purchase an object that is “pre-hung” with the hanging assemblies already attached at the most preferable positions for hanging. Second, the locking nail of each assembly is set at about a ninety-degree angle to the object, the object is placed against the supporting wall in the preferred position, and it is pressed slightly onto the wall, leaving a mark. Third, the locking nail of each mounting assembly is reset to about a forty-five degree angle. Fourth, a nail retainer is affixed, by means of self-adhesive backing, over the marks left on the wall. During this fourth step, the marks may be checked for horizontal positioning, if desired, by using a level, although this is not required if the visual placement of the object is satisfactory. Fifth, the hanging is completed by matching each nail of the mounting assemblies to its respective nail retainer and using hand pressure or light weight pressure to push the nail in and down, securing it the wall.

In the second embodiment of this invention, the process of hanging an object is more simplified. At the second step of the process, the tapered locking nail is screwed into a ninety-degree angled screw bore in each mounting assembly, and this nail will leave a mark in the wall. The rest of the process is followed, except at the third step the nail is unscrewed from the mounting assembly and replaced in the 45-degree hole to complete the mounting.

In the third embodiment, the hanging process is even easier because the screw no longer has to be moved from the 90-degree hole to the 45-degree hole. Instead, the mounting assembly has a marking device in place of the 90-degree screw bore. This is used in the second step of the process to mark the wall. In the third step, the tapered locking screw is screwed into the 45-degree hole in each mounting assembly, and the mounting is then completed by following the rest of the procedure as stated for the first embodiment.

An objective of the present invention is to provide a hanging system that secures an object in a horizontal position and that maintains it in such position, without allowing it to swing or otherwise move. The mounting assembly of the present invention serves as the connection and support for the object while hung, and therefore movement of the object once hung on the wall is eliminated.

A further objective of the present invention is to provide a hanging system that allows for the objects hung to be easily and efficiently relocated with minimal wall damage. Objects hung using the present invention can be lifted up and off the supporting wall and the hanging procedure can be repeated in another location.

Another objective of the present invention is to provide a hanging system that eliminates the difficulty of hanging objects “blind” so that the hanging device can be hidden behind the object. For the present invention, no extra precision measurements are required to accomplish an “invisible” hanging. The mounting assemblies can be easily matched to the nail retainers on the supporting wall and then secured onto the wall by manual pressure.

Yet another objective of the present invention is to provide a hanging device that is simple and inexpensive to manufacture.

Before explaining several embodiments of the present invention in detail, it is to be understood that the present invention is not limited to the details of construction and other arrangements of the components set forth in the following descriptions or illustrated in the drawings. The hanging and mounting device is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

FIG. 1 Cross-section of the mounting assembly at rest, in first embodiment having a locator guide and a nail hinge housing.

FIG. 2 Frontal view of mounting assembly in first embodiment.

FIG. 3 Illustration of the tapered locking nail (common to all embodiments).

FIG. 4 Illustration of the nail hinge housing in first embodiment.

FIG. 5 Frontal view of the locator guide in first embodiment.

FIG. 6 Frontal view of nail retainer

FIG. 7 Perspective view of nail retainer

FIG. 8 Cross-section of hanging in first embodiment as used.

FIG. 9 Cross-section of the mounting assembly at rest, in second embodiment

having no locator guide and two angled screw holes.

FIG. 10 Frontal view of mounting assembly in second embodiment.

FIG. 11 Cross-section of the mounting assembly at rest, in third embodiment

having no locator guide, a single screw hole, and a wall marker.

FIG. 12 Frontal view of mounting assembly in third embodiment.

FIG. 13 3-Dimensional drawing of mounting assembly in second embodiment from side view

FIG. 14 3-Dimensional drawing of mounting assembly in second embodiment from perspective view

### DESCRIPTION OF THE PREFERRED EMBODIMENTS

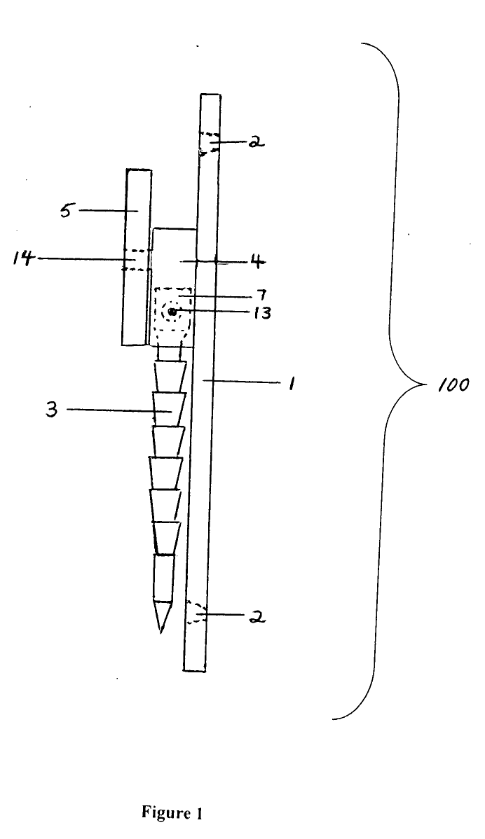

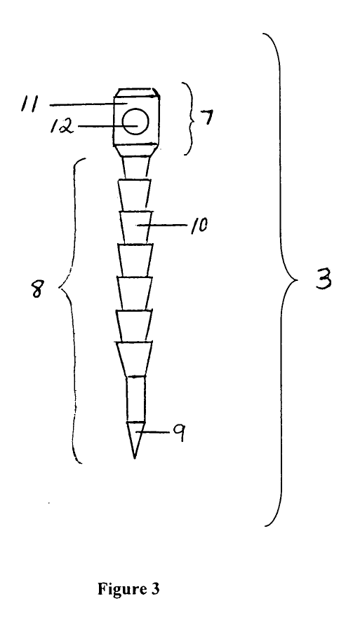

FIG. 1 shows a cross-section of the first embodiment of the mounting assembly 100 at rest. The mounting plate 1 may vary in size to accommodate larger or smaller assemblies depending on the weight of the object being hung, but preferable size is 2 to 3 inches in length, 0.33 to 0.75 inches in width, and 0.20 to 0.60 inches thick. The mounting plate is designed to attach to the object to be hung by a variety of means, including screws, glue, other adhesives, and nails, allowing the person hanging the object to decide the best means for attaching the mounting assembly to the object. The tapered locking nail 3 is shown in its vertical, folded position and is described further in FIG. 3.

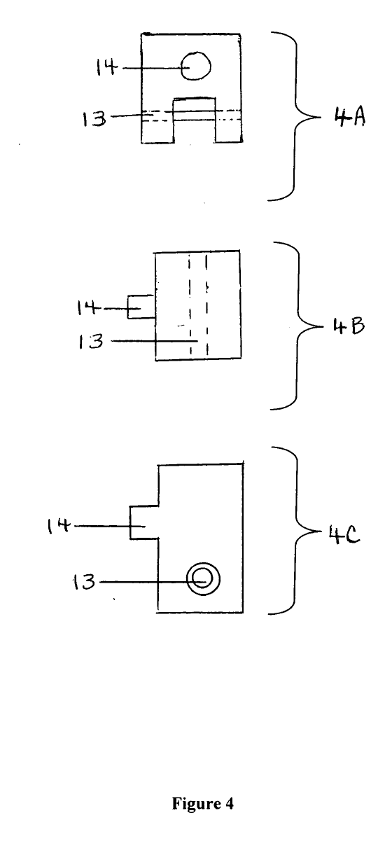

The nail head 7 is pivotably connected to the inside surface of a nail hinge housing 4 by means of a pivot pin 13. Said housing may be integral to the mounting plate or may be attached to it by any secure means including welding, adhesive, screw, or otherwise. This connection means allows the nail to swing outward from the rest position away from the mounting base. The nail hinge housing is described further in FIG. 4.

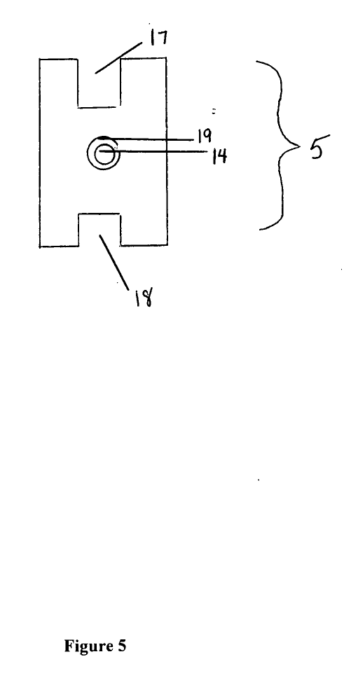

A locator guide 5 is attached to the nail hinge housing on the side opposite of the mounting plate. It is attached by means of a peg 14 integral to the nail housing. The locator guide is thus held adjacent to the upper side of the nail hinge housing. This placement is essential to proper use of the invention. The locator guide is shown in more detail in FIG. 5. Some or all of the various parts of the hanging assembly may be made of plastic or metal materials, and some parts may be made of both metal and plastic in combination, or of composite materials.

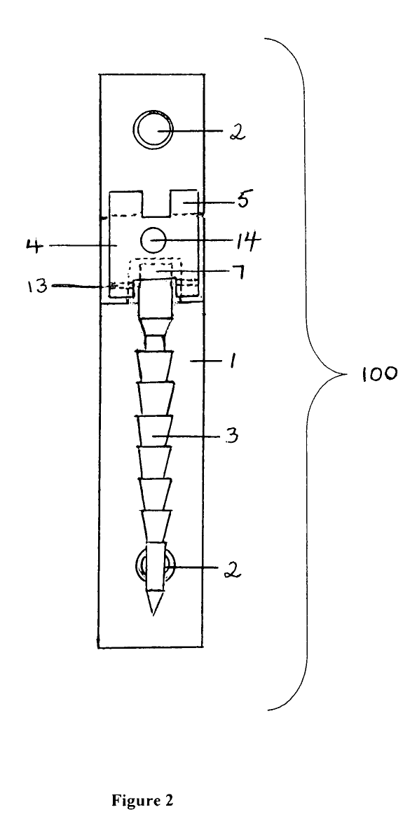

FIG. 2 illustrates a frontal view of the mounting assembly in the first embodiment when at rest. Two holes 2 are provided at either end of the mounting plate 1 to allow the mounting plate to be secured to the hanging object by means of screws, although it may also be secured by glue, other adhesives, nails, and other means. The locator guide 5 is attached to the nail hinge housing 4, with its lower edge matched evenly with the lower edge of the nail hinge housing. The nail hinge housing (see FIG. 4) is sandwiched between the locator guide and the mounting plate, and so is not visible in this view, but a cut-away 7 shows the nail hinge holding the tapered locking nail in place. The tapered locking nail 3 rests parallel to the mounting plate when the assembly is not in use. It is described in detail in FIG. 3.

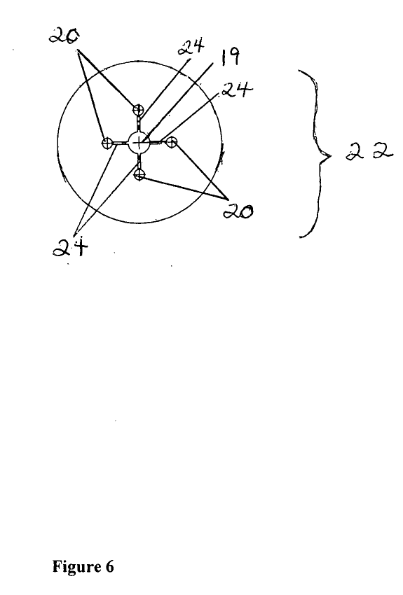

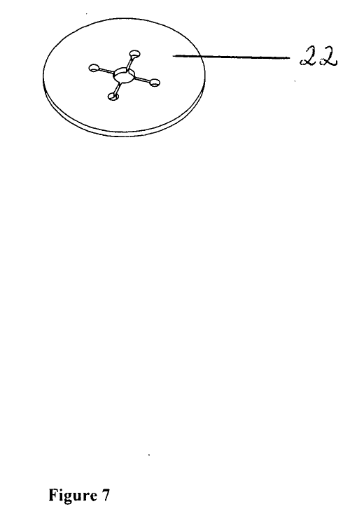

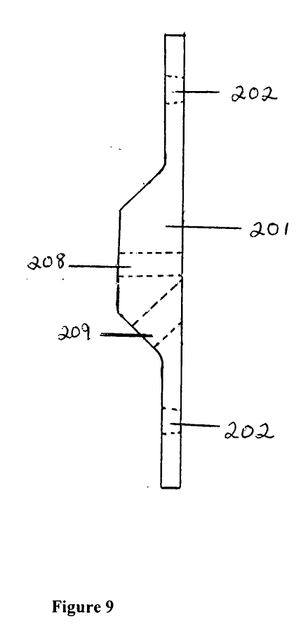

The illustration in FIG. 3 shows the tapered locking nail, which is common to all embodiments of the present invention whenever the assembly is used for mounting an object to a wall. The nail shown in FIG. 3 is in its preferred size of 1.4 inches in length and 0.165 inches in diameter at its head to 0.070 at the start of its tip, which tapers into a sharp point. The nail is constructed to be self-locking into drywall or wallboard through the use of flanges that, in their preferred size flare out at 10 degrees from the nail shaft 8 to a diameter of 0.114 inches. Six flanges are illustrated in this Figure, but the number will vary with the length of the nail. The head of the nail 7 is bordered by 45-degree beveled edges leading into a cylinder 11 that is about 0.213 in length. This cylinder will be screw-threaded for use in the second and third embodiments shown in FIGS. 9 through 12, but for the first embodiment, the head is pierced with a single approximately circular hole of a diameter to allow it to move on the pivot pin 13 (see FIG. 4) in the nail housing. The flanges of the nail have been specially created for purposes of holding and supporting an object securely in a drywall or wallboard wall. After the nail is pushed into the wall through the nail retainer (see FIGS. 6 and 7), the nail flanges will catch into the wall material, reducing movement of the nail and securing it from falling out of the wall, producing a self-locking effect. There is a preferable range to the flange spacing because if it is too small or too large, the flanges will not catch into the wall material sufficiently to secure the nail. The tip of the nail that enters the wall must be a strong, sharply tapered point because it is designed to allow the nail to enter the wall and be pushed into its full hanging position by use of hand pressure alone. The nail may be made of metal or hard plastic or a combination, or of a composite material.

FIG. 4 illustrates the nail hinge housing, which is used in the first embodiment of the present invention as shown in FIGS. 1 and 2. When used, the nail support housing is secured to the mounting plate, as shown in FIG. 1 for purposes of holding the tapered locking nail. In its preferable form, the support housing is ⅝ wide×5/16 inch high by 1/4 inch in depth. In the center, the housing has a ⅛ inch diameter pin 13, providing a hinge for the tapered locking nail shown in FIG. 3. Additionally, the housing has an integral pin 14 for connection of the locator guide 5.

In FIG. 5, the locator guide 5 used in the first embodiment of the present invention FIGS. 1 and 2 is shown from a frontal view. The preferred size of the locator guide is about ⅝ by ⅝ inches and about ¼ inch thick. The size of the guide should match the width of the mounting plate. The guide is pierced with an approximately circular hole 16 about in the center of the guide. Two slots are cut into opposite sides of the guide approximately the width of the size of the diameter of the tapered locking nail, making the guide look approximately like a capital “H.” One slot is cut deeper than the other to allow the tapered locking nail to extend outward from the mounting assembly at different angles depending on which slot is aligned at the lower edge of the nail hinge housing.

The deeper cut 17 allows for an angle of 90 degrees; the other 18, for an angle of 45 degrees. The locator guide is attached by means of a screw passing through the central hole 16 and into the nail support housing in such a fashion that the locator guide can be turned so that the different slots can be placed at the lower edge of the nail hinge housing FIG. 4.

FIG. 6 shows the nail retainer from the frontal view. The nail retainer can vary in size and shape, ranging from approximately circular to square to rectangular depending on manufacturing availability and expense. It is preferably 0.025 inches thick, although this can vary also depending on the manufacturing. The retainer must have an approximately circular hole in the center 19, which is about 0.085 in diameter in its preferable size. This circular hole is “crossed” by two slots 24 of approximately 0.125 inches in length, each ending in a hole that is about 0.040 inches in diameter. A layer of adhesive or other glue-based substance is added to the reverse side of the retainer. A paper or plastic cover that can be stripped off from the retainer just before use protects this substance. The adhesive is used to affix the retainer to the wall in position over the marks left by the mounting assembly.

In FIG. 7, the nail retainer is illustrated from a perspective view.

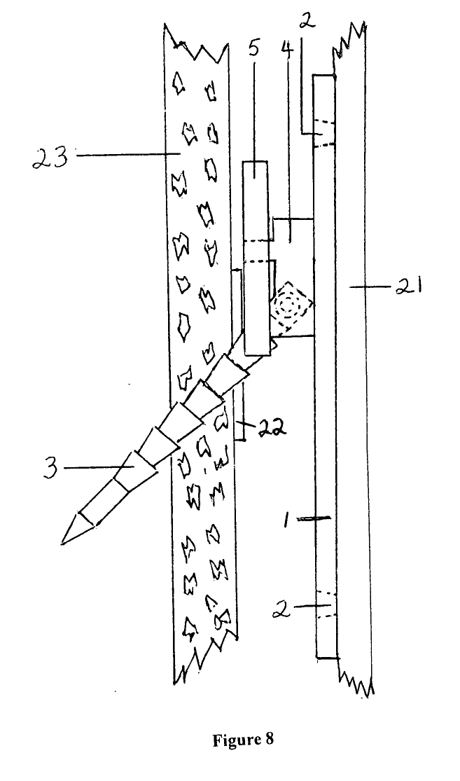

In FIG. 8, the first embodiment of the hanging assembly is illustrated when in use to mount an object to a wall. The hanging assembly is shown in cross-section view. The mounting plate 1 is set against the hanging object 21 and held in place by screws inserted through two holes in the mounting plate 2 and screwed into the frame of the hanging object or into the hanging object itself. The tapered locking nail 3 is extended at a 45 degree angle from the nail hinge housing 4, as limited by the locater guide 5 through the nail retainer 22 and into the wall or other support 23. The locater guide 5 serves to lock the tapered locking nail 3 at a 45-degree angle because the locator guide is turned with the smaller slot downward toward the nail (see FIG. 5).

To hang an object, one or more of the mounting assemblies are attached to the object. This is achieved by means of screws inserted through two holes 2 in the mounting plate 1 and screwed into the object. With the tapered locking nail 3 in closed position parallel to the mounting plate 1, the locator guide 5 is twisted until the larger slot (see FIG. 5) is at the lower edge, above the top of the nail. The tapered locking nail 3 is then pulled into a position that is at a 90-degree angle from the object.

The object is held up in front of the wall 23 and, when the desired position and placement are determined visually, the object is pushed gently against the wall. By this action, the tapered locking nails will mark the wall for purposes of placing the nail retainers 22. The object is then set aside. A nail retainer (see FIGS. 6 and 7) is stripped of its paper or plastic backing to expose the adhesive on the reverse side. It is then placed onto the wall directly over the marking made by the tapered locking nail. If desired, a level can be used to double-check and confirm that the object is being placed in a horizontally level position before the retainers are affixed to the wall.

Once the nail retainers 22 are in place, the hanging object is retrieved and the locator guides 5 are twisted so that the shorter slot (see FIG. 5 is at the lower edge over the tapered locking nail 3. The tapered locking nail is then pulled into a 45-degree angle, as limited by the locater guide. The object is next held so as to match each tapered locking nail 3 to its respective nail retainer 22, and with quick hand pressure, the hanging object is pressed with a downward and forward motion onto the wall. The object is then hung in the desired location. It can be moved and relocated easily by pulling it off of the wall and repeating this same procedure in another place.

FIG. 9 shows a cross-section of the second embodiment of the mounting assembly when at rest. The size, variations in size, and preferable sizes of the parts illustrated in this second embodiment are similar to those described in FIG. 1. In this second embodiment, the mounting plate and nail housing are manufactured as a single integral part 201. The mounting plate is pierced with two holes 202 so it can be attached to the object to be hung, although other means can be used to secure it, including glue, other adhesives, self-locking nails, and so forth. The locator guide and nail hinge are not added because two screw bores are made into the nail housing at the angles of about 90 degrees for 208 and about 45 degrees 209 to the mounting plate. These screw bores are made of a size to accommodate pre-made screw casings or they are machined to the required size for the screw threads on the head of the tapered locking nail (see FIG. 3). The tapered locking nail is not shown because in this second embodiment of the present invention the nail would not normally be in place while the invention is at rest.

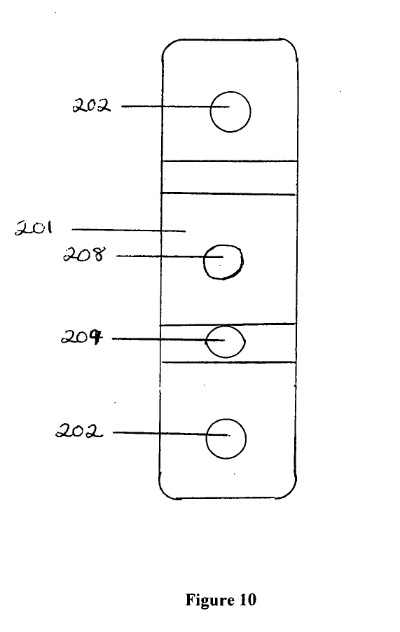

In FIG. 10 is shown the second embodiment of the present invention from a frontal view of the mounting assembly when at rest. Two holes 202 are provided at either end of the mounting plate 201 to allow the mounting plate to be secured to the hanging object by means of screws, although it may also be secured by glue, other adhesives, nails, and other attachment means. The nail hinge and locator guide are not used in this embodiment, and instead the nail housing is manufactured as an integral piece of the mounting plate. The nail housing 204 is shaped with sides rising from the mounting plate at a 45-degree angle and with a top surface planar to the mounting plate. One of the 45-degree sides has a screw bore 209 also at a 45-degree angle to the mounting plate and the top planar surface has a screw bore 208 at a 90-degree angle to the mounting plate. These screw bores are made of a size to accommodate pre-made screw casings or they are machined to the required size for the screw threads on the head of the tapered locking nail (see FIG. 3). The tapered locking nail is not shown because in this second embodiment of the present invention the nail would not be in place while the invention is at rest.

In the second embodiment of the present invention, an object is hung on a wall using a procedure that is similar to the procedure used for the first embodiment. To hang an object, one or more of the mounting assemblies are attached to the object. This is achieved by means of adhesives or screws inserted through two holes 2 in the mounting plate 1 and screwed into the object. The tapered locking nail 3 is screwed into the 90-degree angled screw bore in the mounting plate 208 and the object is then held up in front of the wall. When the desired position and placement are determined visually, the object is pushed gently against the wall. By this action, the tapered locking nails will mark the wall for purposes of placing the nail retainers (see FIG. 6). The object is then set aside. A nail retainer 22 (see FIG. 6) is stripped of its paper or plastic covering to expose the adhesive on the reverse side and it is then placed onto the wall directly over the marking made by the tapered locking nail. If desired, a level can be used to double-check whether the object is being placed in a horizontally level position before the retainers are affixed to the wall.

Once the nail retainers are in place, the hanging object is retrieved and the tapered locking nail is unscrewed from the 90-degree angled hole and screwed into the 45-degree angled hole. The object is next held so as to match each tapered locking nail 3 to its respective nail retainer, and with quick hand pressure or light weight pressure, the hanging object is pressed with a downward and forward motion onto the wall. The object is then hung in the desired location. It can be moved and relocated easily by pulling it off of the wall and repeating this same procedure in another place.

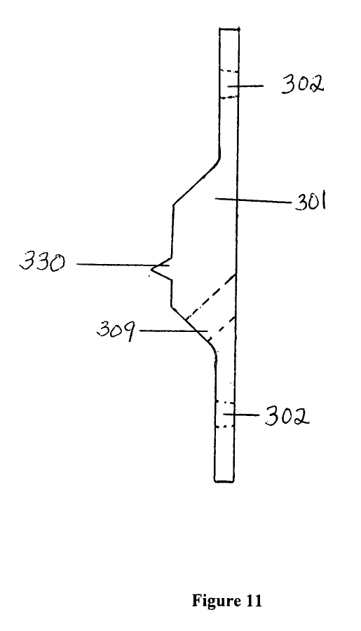

FIG. 11 illustrates a third embodiment of the present invention from a cross-section view of the mounting assembly when at rest. This embodiment is like the second embodiment shown in FIGS. 9, except that there is no 90-degree screw bore in the nail housing. Instead, the planar surface of the nail housing is a platform for a marking device 330, which may take any of several different forms including, but not limited to, a sharp prong device; an ink, chalk, pencil, colored pad, or other marking device; or a sticky device covered with a protective plastic, vinyl, fabric, paper, or other covering that will adhere to the supporting wall.

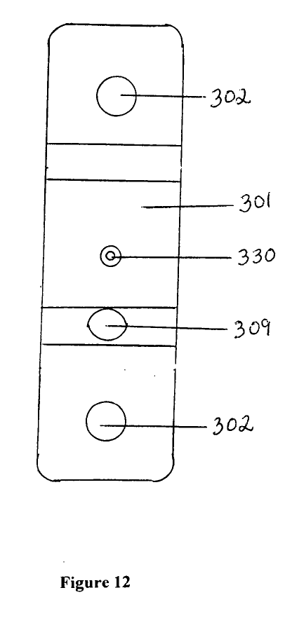

In FIG. 12, the third embodiment of the present invention is shown from a frontal view when at rest. This embodiment is similar to the second embodiment shown in FIG. 10, except that there is no 90-degree screw bore in the nail housing. Instead, the planar surface of the nail housing is a platform for a marking device 330 as described in FIG. 11.

In the third embodiment of the present invention, an object is hung on a wall using a procedure that is similar to the procedure used for the second embodiment. To hang an object, one or more of the mounting assemblies are attached to the object. This is achieved by means of adhesives or screws inserted through two holes 302 in the mounting plate 301 and screwed into the object. The object is then held up in front of the wall. When the desired position and placement are determined visually, the object is pushed gently against the wall. By this action, the marking device will mark the wall for purposes of placing the nail retainers (see FIG. 6). The object is then set aside. A nail retainer is stripped of its paper or plastic covering to expose the adhesive on the reverse side and it is then placed onto the wall directly over the marking made by the marking device. If desired, a level can be used to double-check whether the object is being placed in a horizontally level position before the retainers are affixed to the wall.

Once the nail retainers are in place, the hanging object is retrieved and the tapered locking nail is screwed into the 45-degree angled hole. The object is next held so as to match each tapered locking nail 3 to its respective nail retainer, and with quick hand pressure or light weight pressure, the hanging object is pressed with a downward and forward motion onto the wall. The object is then hung in the desired location. It can be moved and relocated easily by pulling it off of the wall and repeating this same procedure in another place.

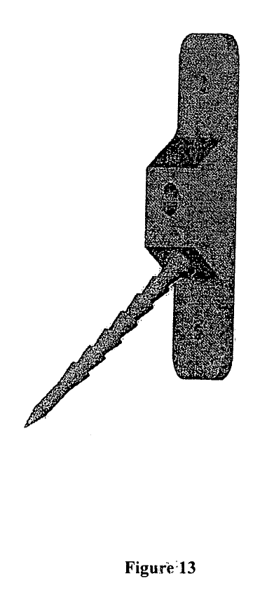

FIG. 13 is a 3-dimensional drawing of a mounting assembly in the second embodiment of the present invention. The mounting assembly is shown from a side view with the tapered locking nail screwed into the 45-degree angle screw bore of the nail housing.

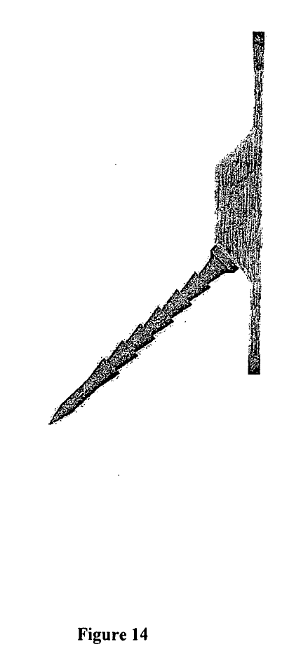

In FIG. 14, the same mounting assembly shown in FIG. 13 is illustrated from a perspective view. This is the second embodiment of the present invention, and the tapered locking nail is again shown while screwed into the 45-degree angle screw bore of the nail housing.

What is claimed is:

1. A hanging system for hanging an object on a vertical or vertically angled support, having a base plate for attachment to the object, attachment means secured by means of a support housing, held at a specified angle by means of a locator guide.

2. The hanging system of claim 11 wherein said nail is fastened to the vertical or vertically angled support through a nail retainer.

3. A hanging system as described in claim 11 wherein said locator guide is capable of guiding said nail at 45 degrees and at 90 degrees from vertical.

4. A hanging system as described in claim 1 wherein said locator guide contains means for marking a location on a vertical support, said location being a suitable location for hanging the object.

5. A hanging system as described in claim 1 wherein said system is constructed of metal, hard plastic, or composite materials.

6. A hanging system as described in claim 1 wherein said base plate is attached to said object by glue, nails, screws, or other conventional attachment means.

7. A process for hanging an object on a substantially vertical surface, said process comprising the steps of:
a. affixing a hanging system containing a locator guide therein to the back of the object to be hung on the vertical surface, by means of a base plate;
b. using said locator guide to select a sutable position for hanging said object;
c. locating the object in the previously selected position;
d. using fastening means within said system to fasten said object to the vertical surface.

8. {Canceled}

9. {Canceled}

10. {Canceled}

11. A hanging system as described in claim 1 wherein said attachment means comprises a nail.

12. A hanging system for hanging an object on a vertical or vertically angled support, having a base plate for attachment to the object, attachment means comprising a tapered locking nail, secured by means of a support housing, and held at a specified angle by means of a locator guide.

13. The hanging system of claim 12 wherein said nail is fastened to the vertical or vertically angled support through a nail retainer.

14. The hanging system as described in claim 12 wherein said locator guide is capable of guiding said nail at 45 degrees and at 90 degrees from vertical.

15. The hanging system as described in claim 12 wherein said locator guide contains means for marking a location on a vertical support, said location being a is suitable location for hanging the object.

16. The hanging system as described in claim 12 wherein said system is constructed of metal, hard plastic, or composite materials.

17. The hanging system as described in claim 12 wherein said base plate is attached to said object by glue, nails, screws, or other conventional attachment means.
